(19) United States
(12) Patent Application Publication
(10) Pub. No.: US 2017/0289410 A1
(43) Pub. Date: Oct. 5, 2017

(54) DEVICE, SYSTEM AND METHOD TO MITIGATE LOSS OF SIGNAL INTEGRITY IN A COMMUNICATION OF IMAGE INFORMATION

(71) Applicant: Intel Corporation, Santa Clara, CA (US)

(72) Inventors: Mohd Muhaiyiddin Bin Abdullah, Kepala Batas (MY); Chee Kit Chew, Georgetown (MY); Chung-Hao Chen, Portland, OR (US)

(21) Appl. No.: 15/085,926

(22) Filed: Mar. 30, 2016

(51) Int. Cl. H04N 5/213; G06T 5/20

(52) U.S. Cl. CPC H04N 5/213; G06T 5/20

(57) ABSTRACT

Techniques and mechanisms for exchanging image data via a three-wire data channel of an interconnect, at least a portion of which is disposed in or on a substrate of a printed circuit board. In an embodiment, three data signals are concurrently exchanged in parallel, each via a different respective trace portion of the data channel. The substrate has disposed therein or thereon three filter structures each to perform filtering of a different respective one of the three signals. The filter structures each include a respective sequence of corrugations to increase a stray capacitance provided by a substrate material. In another embodiment, the interconnect is compatible with a Mobile Industry Processor Interface (MIPI) camera physical layer interface (C-PHY) standard.

### BACKGROUND

1. Technical Field

Embodiments described herein relate generally to image devices and more particularly, but not exclusively, to mitigating signal jitter in the communication of image information.

2. Background Art

The camera physical layer (C-PHY) specification released Sep. 17, 2014 defines an interface standard tailored to the communication of image data with a camera. Interfaces compatible with Mobile Industry Processor Interface (MIPI) C-PHY variously employ multi-level signaling using a data channel comprising three parallel signal traces (or “wires”). In such a signaling scheme, two of the three wires are driven to opposite levels while the third wire is terminated to a mid-level. The respective voltages at which the three wires are variously driven is subsequently changed, over time, to represent a sequence of data symbols.

Process, voltage and temperature variations across integrated circuit devices tend to result in channel skew and/or channel loss characteristics that result in poor and/or inconsistent signal integrity in communication via MIPI C-PHY (or other) interfaces. As successive generations of image sensor devices continue to trend toward higher pixel density and faster operational rates, there is expected to be an increasing premium placed on incremental improvements in the communication of image information with such devices.

### BRIEF DESCRIPTION OF THE DRAWINGS

The various embodiments of the present invention are illustrated by way of example, and not by way of limitation, in the figures of the accompanying drawings and in which:

FIG. 1 is a perspective view of a device including circuit structures to communicate image information according to an embodiment.

FIG. 2 is a flow diagram illustrating elements of a method to communicate image information according to an embodiment.

FIG. 3 is a circuit diagram illustrating elements of a system to exchange image information according to an embodiment.

FIG. 4 is a layout diagram illustrating circuit structures of a device to communicate image information according to an embodiment.

FIG. 5 is a block diagram illustrating elements of a computing system for communicating sensor information according to an embodiment.

FIG. 6 is a block diagram illustrating elements of a mobile device for communicating sensor information according to an embodiment.

### DETAILED DESCRIPTION

Embodiments of the invention relate generally to techniques and mechanisms for mitigating signal jitter in an interface, such as one that is compatible with a physical layer (PHY) standard, which includes three traces coupled in parallel for the communication of an image data symbol.

Some embodiments are based at least in part on a realization that the integrity of image (or other) data is being increasingly impacted by signal jitter which results from circuit switching during communication via a three-wire data channel (such as one according to MIPI C-PHY). As compared to MIPI C-PHY, various other camera interface technologies tend to be implemented in relatively short channels which do not present significant signal jitter. C-PHY interfaces can be expected to be increasingly impacted by signal jitter as imaging technology continues to increase the volume of data being generated by sensor devices, as well as the operational speeds of such devices. Certain embodiments support improved signaling via otherwise typical C-PHY hardware and/or allows for extension of C-PHY for use in longer data channels, higher data rates and/or lower power states.

In an embodiment, an integrated circuit (IC) device is to function as a source (or alternatively, as a sink) of image data. The IC device may be coupled, directly or indirectly, to exchange the image data via a substrate such as that of a printed circuit board. For example, circuit structures variously disposed in or on the substrate may include three conductive traces of a MIPI C-PHY (or other) interface. Such circuit structures may further include filter structures (also referred to herein as “filters”) that are each coupled to a respective one of the conductive traces. In one embodiment, the filter structures variously operate each as a respective high-cut filters to reduce switching jitter by mitigating, for example, variation between the respective rise times of signals exchanged via different respective wires of a MIPI C-PHY trio. As used herein with respect to filters, “high-cut” refers to the characteristic of preventing communication of one or more frequencies that are relatively higher than one or more other frequencies which are allowed to be communicated (or “passed”). A high-cut filter may include, for example, a low-pass filter (LPF) or a band-pass filter (BPF).

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. Such devices may be portable or stationary. In some embodiments the technologies described herein may be employed in a desktop computer, laptop computer, smart phone, tablet computer, netbook computer, notebook computer, personal digital assistant, server, combinations thereof, and the like. More generally, the technologies described herein may be employed in any of a variety of electronic devices including a three trace (colloquially referred to as “three-wire”) interface architecture.

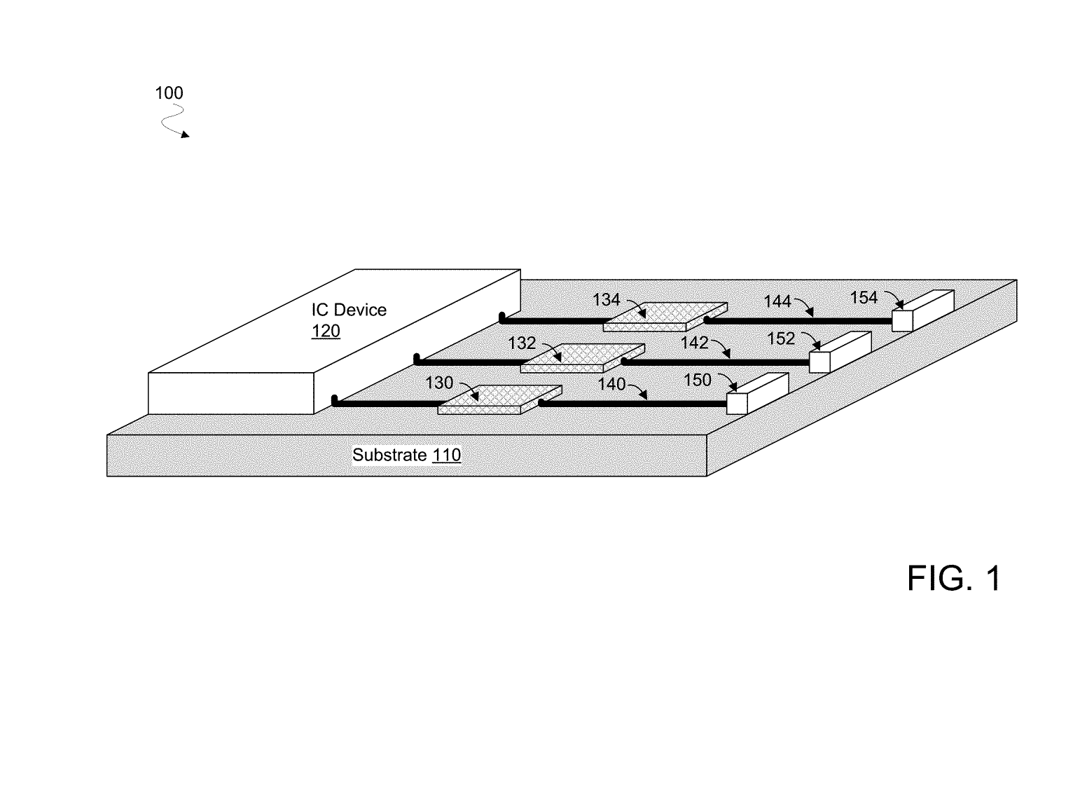

FIG. 1 shows features of a device 100 to mitigate the effect of signal jitter in a three-wire data channel according to an embodiment. Device 100 may include a processing-capable platform and/or provide functionality to operate as a component of such a platform. In the illustrative embodiment shown, device 100 includes a substrate 110 and an IC device 120 coupled thereto. Device 120 may be an IC chip that, for example, is to couple to another IC chip which includes, or is coupled to, substrate 110. For example, substrate 110 may function as at least part of an interposer of a packaged IC device which includes both IC chip 120 and one or more other IC chips. In such an embodiment, device 100 may be a packaged IC device—e.g., including IC chips arranged in a side-by-side configuration.

Alternatively, IC device 120 may itself be a packaged device that is to couple to external circuitry via substrate 110. For example, substrate 110 may be a main body portion of a motherboard, or other printed circuit board (PCB), including any of a variety of substrate materials and/or structures suitable to support coupling to, and operation with, one or more packaged IC devices. For example, materials used in conventional PCB manufacture techniques may be adapted to fabricate substrate 110—e.g., where such materials include, but are not limited to, any of various FR4 materials, composite epoxy materials (such as CEM-3), epoxy resins, polyimides, triazine resins and/or the like. Substrate 110 may have disposed therein one or more vias, traces, metallization layers and/or other interconnect structures to enable connection between device 120 and components that are disposed in or on, or are to couple to, substrate 110.

In an embodiment, IC device 120 is to function as a source—or alternatively, as a sink—of image data that is to be exchanged with another device (not shown) via an interconnect formed at least in part in substrate 110. By way of illustration and not limitation, a three-wire data channel of the interface may include conductive trace portions 140, 142, 144. The interconnect may include one or more additional conductive traces (not shown) that, for example, are to exchange control messages, configuration settings and/or other information besides payload sensor data such as image pixel data. In an embodiment, the interconnect is compatible with an interface standard, such as that of a MIPI C-PHY specification, which defines a three-wire data channel architecture.

Trace portions 140, 142, 144 may be variously coupled each between a respective input and/or output (I/O) contact of IC device 120 and a respective one of terminals 150, 152, 154. In an embodiment, each of trace portions 140, 142, 144 is to concurrently exchange between terminals 150, 152, 154 and IC device 120 a different respective one of signals that, together, are to represent image data. Terminals 150, 152, 154 represent any of a variety of conductive sockets, pads, bumps, pins and/or other connector structures that variously provide for connection between traces 140, 142, 144 and other circuitry (not shown) that is to exchange the image data with IC device 120. Such other circuitry may be a component of device 100 or, alternatively, may couple directly or indirectly to device 100.

To mitigate the possible effects of signal jitter, the interconnect may further comprise filter structures 130, 132, 134 each disposed in or on substrate 110. The filter structures 130, 132, 134 may each be coupled to a respective one of conductive trace portions 140, 142, 144. Filter structures 130, 132, 134 may variously operate to mitigate the propagation of relatively high-frequency signal components by trace portions 140, 142, 144. In an embodiment, some or all of filter structures 130, 132, 134 are embedded at least in part within a bulk material of substrate 110.

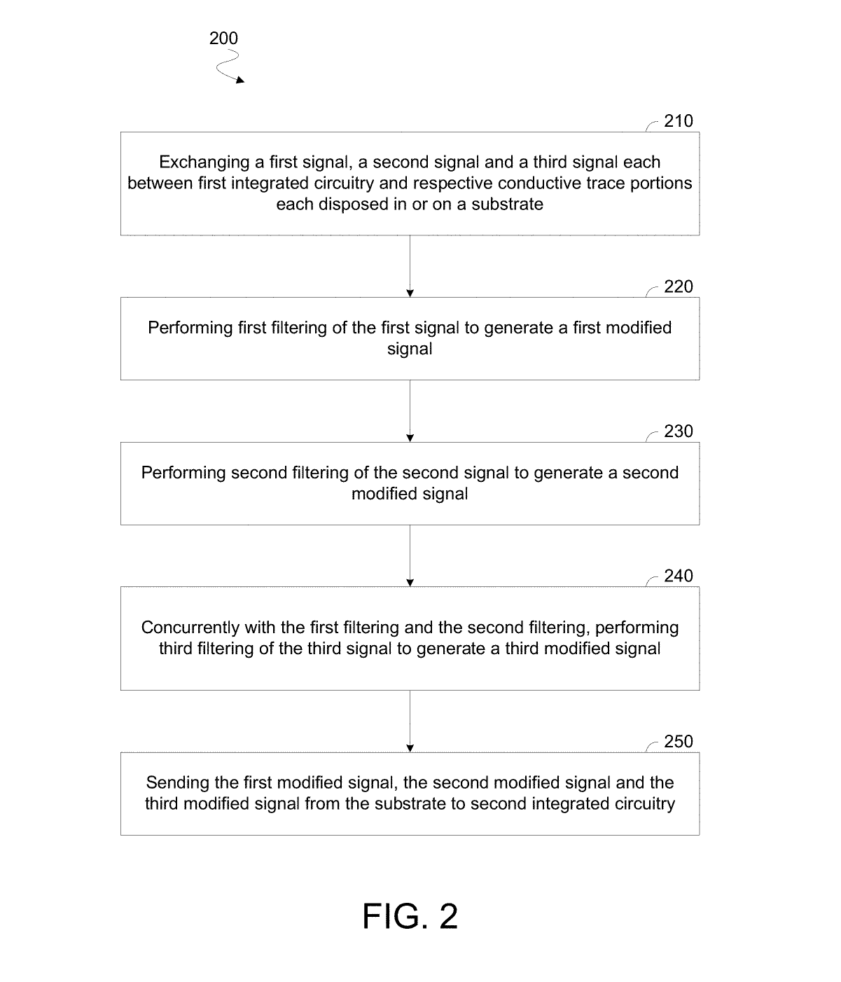

FIG. 2 illustrates elements a method 200 to exchange image data according to an embodiment. Method 200 is one example of a technique to mitigate signal jitter that might otherwise degrade communication via a three-wire data channel such as one that is compatible with a camera physical layer (C-PHY) standard. Method 200 may be performed by a hardware having some or all of the features of device 100, for example.

In an embodiment, method 200 includes, at 210, exchanging a first signal, a second signal and a third signal (also referred to herein as a “signal triad”) each between first integrated circuitry and respective conductive trace portions each disposed in or on a substrate. The exchanging at 210 may include, for example, exchanging signals between IC device 120 and different respective I/O contacts that are formed on substrate 110. The first integrated circuitry may function as a source of image data—e.g., where the first integrated circuitry includes or couples to image sensor circuitry that generates imaging data. In an embodiment, the first, second and third signals may constitute an encoded representation of pixel data and/or other image sensor information. For example, a combination of each of the first signal, the second signal and the third signal may communicate a symbol representing image data. In an embodiment, the first, second and third signals communicate image information according to a standard encoding scheme and/or protocol such as that defined in, or otherwise indicated by, a MIPI C-PHY specification.

Method 200 may further comprise, at 210, performing first filtering of the first signal to generate a first modified signal and, at 220, performing second filtering of the second signal to generate a second modified signal. Concurrently with the first filtering at 220 and the second filtering at 230, method 200 may further perform, at 240, third filtering of the third signal to generate a third modified signal. The various filtering at 220, 230 and 240 may be performed by respective filter structures that are each disposed in or on the substrate—e.g., where such filter structures each comprise respective conductive trace portions that are formed in a bulk substrate material and/or formed on a side of the bulk substrate material.

In some embodiments, method 200 further includes, at 250, sending the first modified signal, the second modified signal and the third modified signal (a “modified signal triad”) from the substrate to second integrated circuitry. For example, the second integrated circuitry may include a receiver PHY (and/or a transmitter PHY) that is coupled directly or indirectly to the substrate. The second integrated circuitry may be disposed in a packaged IC device that is coupled to a PCB which includes the substrate.

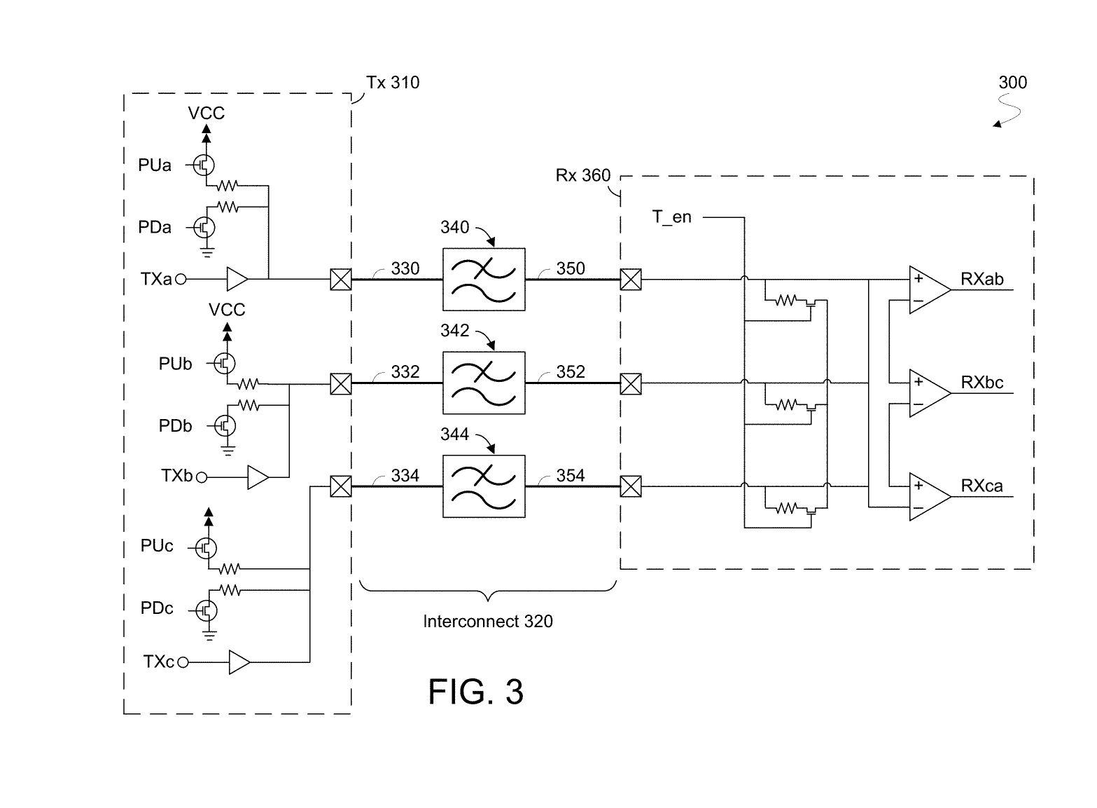

FIG. 3 is a circuit diagram representation of a system 300 to communicate image information according to an embodiment. System 300 may provide functionality to perform some or all operations of method 200, for example. In an embodiment, system 300 includes a transmitter Tx 310 and a receiver Rx 360 coupled to one another via an interconnect 320. Tx 310 and Rx 360 may function as source and sink, respectively, of image data exchanged by interconnect 320. Interconnect 320 may include a data channel including three parallel signal lines. The data channel may be compatible with an interface standard such as that of a MIPI C-PHY specification.

In the illustrative embodiment shown, three input data signals TXa, TXb, TXc are provided to TX 310—e.g., by an encoder (not shown) that supports a MIPI C-PHY compatible encoding scheme. Such an encoder may be a component of Tx 310 or, alternatively, coupled to Tx 310. Transitions of TXa—e.g., between a logic high state and a logic low state—may be assisted at least in part by transistor circuitry variously coupled between a supply voltage VCC, a pull-up reference signal PUa and a pull-down reference signal PDa. Alternatively or in addition, reference signals PUb, PDb may be similarly coupled to assist logic transitions of TXb and/or reference signals PUc, PDc may be similarly coupled to assist logic transitions of TXc. The particular transmit circuitry of Tx 310 is merely illustrative, and not limiting one some embodiments.

Some or all of interconnect 320 may be disposed in or on a bulk material (not show) of a substrate such as that of a PCB. For example, interconnect 320 may include trace portions 330, 332, 334 each coupled to a different respective output terminal of Tx 310. Trace portions 330, 332, 334 may each be coupled to respective filters 340, 342, 344 disposed in or on the substrate. In turn, filters 340, 342, 344 may be coupled via respective trace portions 350, 352, 354 each to a corresponding input terminal of Rx 360. Some or all of trace portions 330, 332, 334, 350, 352, 354 and filters 340, 342, 344 may be variously formed within, or at a side of, a PCB or other substrate structure coupling Tx 310 to Rx 360.

Input terminals of Rx 360 may each receive a respective filtered version of one of TXa, TXb, TXc. In the illustrative embodiment shown, Rx 360 includes differential amplifiers (and/or other circuitry) coupled to at least partially decode the respective filtered versions of TXa, TXb and TXc into signals RXab RXbc, RXca. Together, the decoded signals RXab RXbc, RXca may communicate a symbol representing image data from Tx 310. Although certain embodiments are not limited in this regard, such decoding may be controlled by an enable signal T_en.

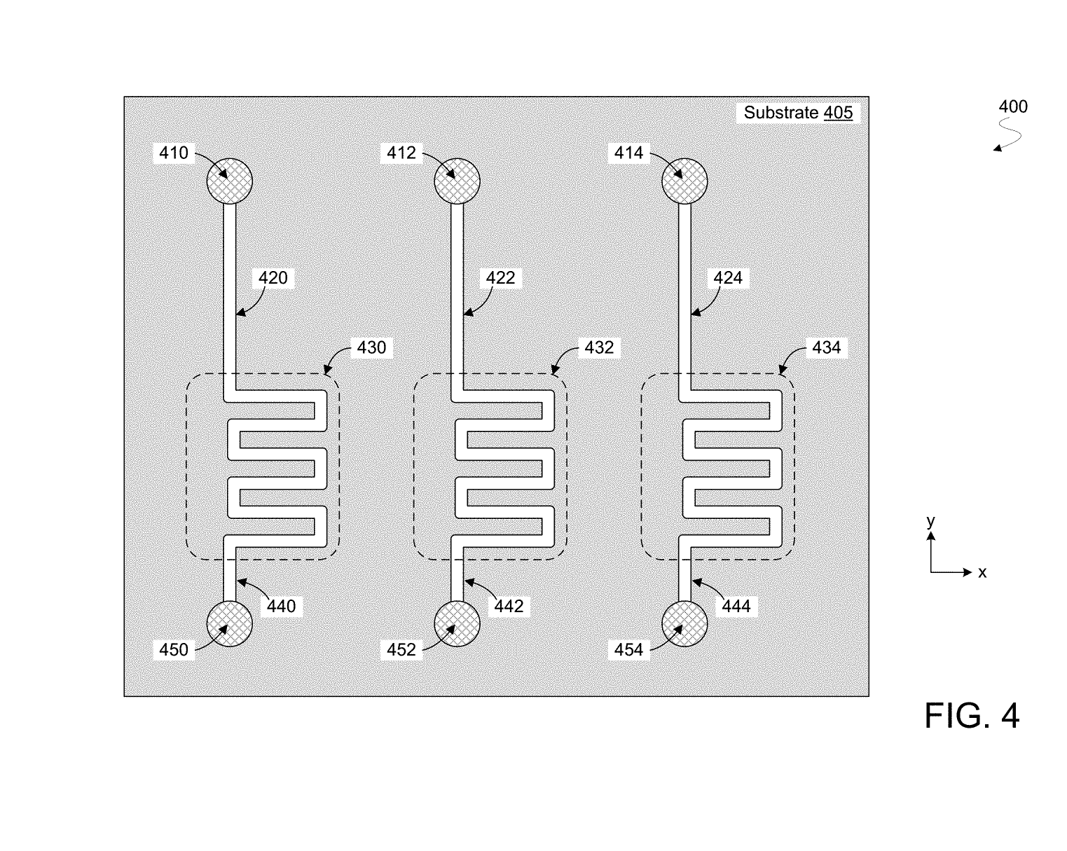

FIG. 4 shows a plan view of a device 400 to communicate image information according to an embodiment. Device 400 may include some or all of the features of device 100—e.g., where device 400 includes (or is to couple to) one or both of Tx 310 and Rx 360. In an embodiment, method 200 is performed with structures of device 400.

Device 400 includes a substrate 405 and metallization structures formed therein or thereon. In one illustrative embodiment, substrate 405 (e.g., substrate 110) includes a bulk material such as that of a PCB. Metallization structures variously disposed in or on substrate 405 may form a data channel that, for example, is to interconnect first and second integrated circuitry (not shown), one or both of which may be part of device 400.

The data channel may be compatible with a MIPI C-PHY standard, for example. In an embodiment, device 400 includes contacts 410, 412, 414 variously disposed on substrate 405, where such contacts 410, 412, 414 are each to couple to a respective I/O terminal of the first integrated circuitry. Similarly, other contacts 450, 452, 454 disposed on substrate 405 may be configured for coupling to respective terminals of the second integrated circuitry. A first signal path of the data channel may include trace portions 420, 440 and a filter 430—e.g., where a second signal path of the data channel includes trace portions 422, 442 and a filter 432, and where a third signal path of the data channel includes trace portions 424, 444 and a filter 434. Formation of such circuit structures in or on substrate 405 may include mask, etch, plating and/or other processing adapted from conventional fabrication techniques. The details of such techniques are not detailed herein to avoid obscuring certain features of various embodiments.

Filters 430, 432, 434 may be variously coupled to receive, concurrently, respective ones of three signals which, together, communicate one or more symbols representing image data. Filters 430, 432, 434 may each comprise a respective series of corrugation structures. For example, trace portions 420, 440 may variously communicate a signal along a y-axis direction, where conductive structures of filter 430 variously arc, bend and/or otherwise extend to provide for propagation of such a signal, at least in part, back and forth along an x-axis direction. The corrugation structures of filter 430 may increase stray inductive effects and/or increase stray capacitive effects of the nearby bulk material of substrate 405, where such effects contribute to signal filtering characteristics. The range of signal frequencies to be filtered (or alternatively, passed) by a given filter structure may depends on any of a variety of factors including, but not limited to, signal data rates, circuit board dimensions and layout, data encoding schemes and/or the like. Although some embodiments are not limited in this regard, the capacitances variously provided with filters 430, 432, 434 may include two capacitances that differ by at least five percent (5%) from each other—e.g., where such capacitances differ by at least ten percent (10%).

The increased stray inductance and/or stray capacitance may result in attenuation of some signal components—e.g., as compared to relatively lower frequency signal components that are also being propagated by filter 430. As a result, such corrugation structures may contribute to high-cut (e.g., low-pass or band-pass) filter characteristics of filter 430. Alternatively or in addition, corrugation structures of filter 432 may facilitate high-cut filtering of a signal that is concurrently exchanged between trace portions 422, 442 and/or corrugation structures of filter 434 may facilitate high-cut filtering of another signal that is concurrently exchanged between trace portions 424, 444.

Although some embodiments are not limited in this regard, the circuit structures shown for device 400 occupy a footprint that is equal to or less than a 1 square centimeter (cm²) region of a PCB. By way of illustration and not limitation, the three-wire data channel coupled between contacts 410, 412, 414 and contacts 450, 452, 454 may reside within a 10 square millimeter (mm²) cross-sectional area of device 400—e.g., where the data channel is within a 5 mm by 1 mm area. However, such dimensions may vary significantly according to implementation-specific details.

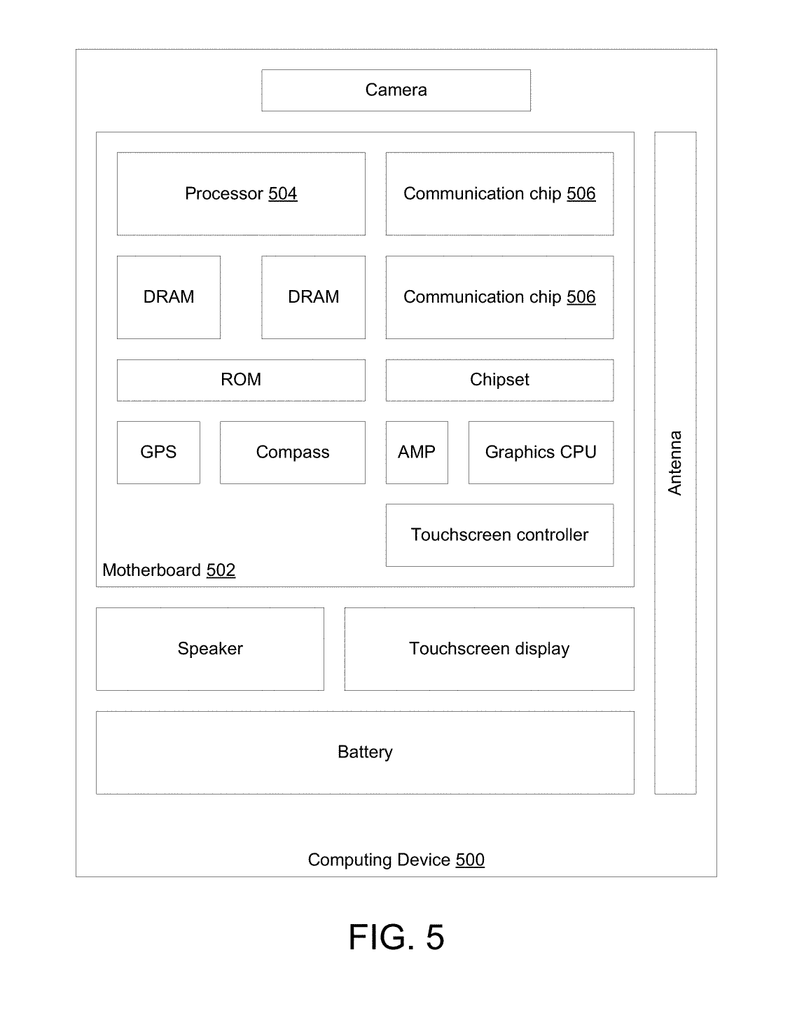

FIG. 5 illustrates a computing device 500 in accordance with one embodiment. The computing device 500 houses a board 502. The board 502 may include a number of components, including but not limited to a processor 504 and at least one communication chip 506. The processor 504 is physically and electrically coupled to the board 502. In some implementations the at least one communication chip 506 is also physically and electrically coupled to the board 502. In further implementations, the communication chip 506 is part of the processor 504.

Depending on its applications, computing device 500 may include other components that may or may not be physically and electrically coupled to the board 502. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 506 enables wireless communications for the transfer of data to and from the computing device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 506 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 500 may include a plurality of communication chips 506. For instance, a first communication chip 506 may be dedicated to shorter range wireless communications such as Wi-Fi and Bluetooth and a second communication chip 506 may be dedicated to longer range wireless communications such as GPS, EDGE, GPRS, CDMA, WiMAX, LTE, Ev-DO, and others.

The processor 504 of the computing device 500 includes an integrated circuit die packaged within the processor 504. The term “processor” may refer to any device or portion of a device that processes electronic data from registers and/or memory to transform that electronic data into other electronic data that may be stored in registers and/or memory. The communication chip 506 also includes an integrated circuit die packaged within the communication chip 506.

In various implementations, the computing device 500 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 500 may be any other electronic device that processes data.

Some embodiments may be provided as a computer program product, or software, that may include a machine-readable medium having stored thereon instructions, which may be used to program a computer system (or other electronic devices) to perform a process according to an embodiment. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

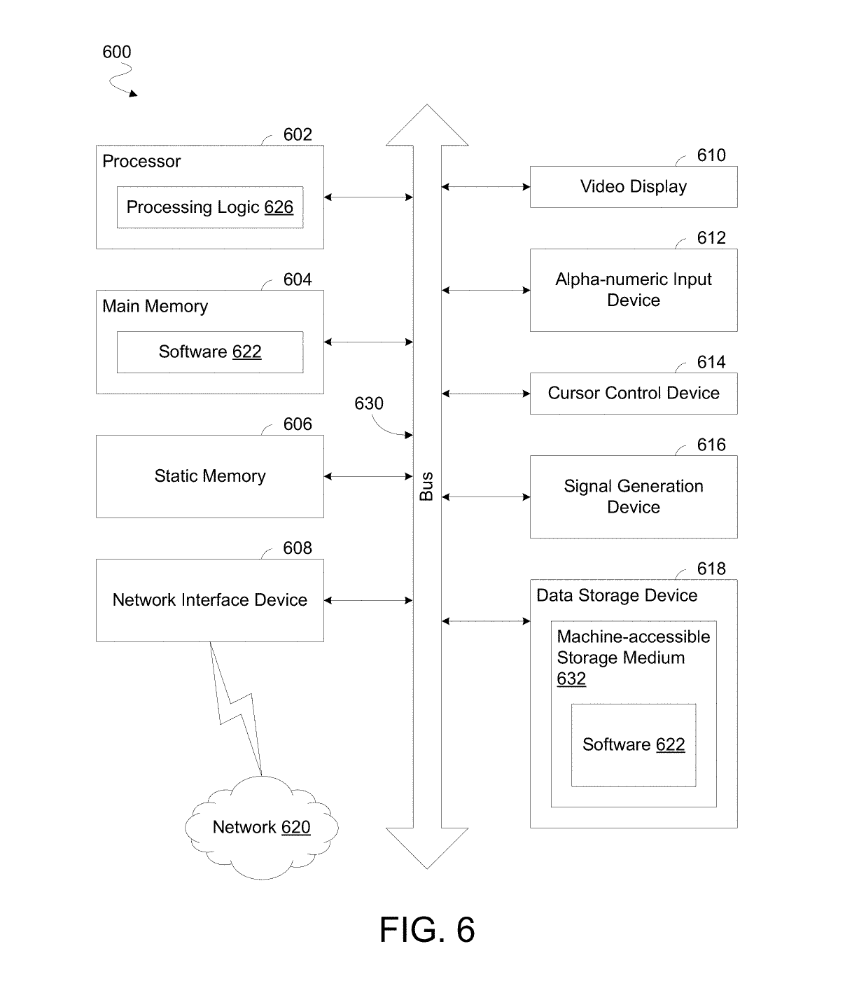

FIG. 6 illustrates a diagrammatic representation of a machine in the exemplary form of a computer system 600 within which a set of instructions, for causing the machine to perform any one or more of the methodologies described herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies described herein.

The exemplary computer system 600 includes a processor 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a secondary memory 618 (e.g., a data storage device), which communicate with each other via a bus 630.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 602 may also be one or more special-purpose processing devices such as an application specific integrated circuit (ASIC), a field programmable gate array (FPGA), a digital signal processor (DSP), network processor, or the like. Processor 602 is configured to execute the processing logic 626 for performing the operations described herein.

The computer system 600 may further include a network interface device 608. The computer system 600 also may include a video display unit 610 (e.g., a liquid crystal display (LCD), a light emitting diode display (LED), or a cathode ray tube (CRT)), an alphanumeric input device 612 (e.g., a keyboard), a cursor control device 614 (e.g., a mouse), and a signal generation device 616 (e.g., a speaker).

The secondary memory 618 may include a machine-accessible storage medium (or more specifically a computer-readable storage medium) 632 on which is stored one or more sets of instructions (e.g., software 622) embodying any one or more of the methodologies or functions described herein. The software 622 may also reside, completely or at least partially, within the main memory 604 and/or within the processor 602 during execution thereof by the computer system 600, the main memory 604 and the processor 602 also constituting machine-readable storage media. The software 622 may further be transmitted or received over a network 620 via the network interface device 608.

While the machine-accessible storage medium 632 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any of one or more embodiments. The term “machine-readable storage medium” shall accordingly be taken to include, but not be limited to, solid-state memories, and optical and magnetic media.

In one implementation, a device comprises a substrate having disposed therein or thereon a first filter structure to perform a first filtering of a first signal to generate a first modified signal, a second filter structure to perform a second filtering of a second signal to generate a second modified signal, and a third filter structure to perform, concurrently with the first filtering and the second filtering, a third filtering of a third signal to generate a third modified signal, wherein a combination of the first signal, the second signal and the third signal communicate a symbol representing image data. The device further comprises first integrated circuitry coupled to concurrently exchange with the substrate one of a first signal triad including the first signal, the second signal and the third signal, and a second signal triad including the first modified signal, the second modified signal and the third modified signal.

In an embodiment, the device includes a printed circuit board comprising the substrate. In another embodiment, an interconnect, at least partially disposed in or on the substrate, includes the first filter structure, the second filter structure and the third filter structure, wherein the interconnect is compatible with a camera physical layer standard. In another embodiment, the camera physical layer standard defined by a MIPI C-PHY specification. In another embodiment, the first filter structure, the second filter structure and the third filter structure each include a respective conductive trace portion that forms a sequence of corrugations in or on the substrate. In another embodiment, three capacitances are each to be provided with different respective one of the first filter structure, the second filter structure and the third filter structure, wherein one of the three capacitances differs by at least five percent from another of the three capacitances. In another embodiment, the one of the three capacitances differs by at least ten percent from the other of the three capacitances. In another embodiment, a three-wire data channel, disposed in or on the substrate, includes the first filter structure, the second filter structure and the third filter structure, wherein the three-wire data channel is located within a region of the substrate, wherein a total cross-sectional area of the region is equal to or less than a 1 square centimeter.

In another implementation, a method comprises concurrently performing each of first filtering of a first signal with a first filter structure, wherein the first filtering generates a first modified signal, second filtering of a second signal with a second filter structure, wherein the second filtering generates a second modified signal, and third filtering of a third signal with a third filter structure, wherein the third filtering generates a third modified signal, wherein the first signal, the second signal and the third signal are provided by first integrated circuitry coupled to a substrate, wherein the first filter structure, the second filter structure and the third filter structure are each disposed in or on the substrate, wherein a combination of the first signal, the second signal and the third signal communicate a symbol representing image data. The method further comprises sending the first modified signal, the second modified signal and the third modified signal from the substrate to second integrated circuitry.

In an embodiment, a printed circuit board includes the substrate. In another embodiment, an interconnect, at least partially disposed in or on the substrate, includes the first filter structure, the second filter structure and the third filter structure, wherein the interconnect is compatible with a camera physical layer standard. In another embodiment, the camera physical layer standard defined by a MIPI C-PHY specification. In another embodiment, the first filter structure, the second filter structure and the third filter structure each include a respective conductive trace portion that forms a sequence of corrugations in or on the substrate. In another embodiment, the method further comprises providing three capacitances each with a different respective one of the first filter structure, the second filter structure and the third filter structure, wherein one of the three capacitances differs by at least five percent from another of the three capacitances. In another embodiment, the one of the three capacitances differs by at least ten percent from the other of the three capacitances. In another embodiment, a three-wire data channel, disposed in or on the substrate, includes the first filter structure, the second filter structure and the third filter structure, wherein the three-wire data channel is located within a region of the substrate, wherein a total cross-sectional area of the region is equal to or less than a 1 square centimeter.

In another implementation, a system comprises a device including a substrate having disposed therein or thereon a first filter structure to perform a first filtering of a first signal to generate a first modified signal, a second filter structure to perform a second filtering of a second signal to generate a second modified signal, and a third filter structure to perform, concurrently with the first filtering and the second filtering, a third filtering of a third signal to generate a third modified signal, wherein a combination of the first signal, the second signal and the third signal communicate a symbol representing image data. The device further comprises first integrated circuitry coupled to concurrently exchange with the substrate one of a first signal triad including the first signal, the second signal and the third signal, and a second signal triad including the first modified signal, the second modified signal and the third modified signal. The system further comprises a display coupled to the substrate, the display to generate an image based on the image data.

In another embodiment, the device includes a printed circuit board comprising the substrate. In another embodiment, an interconnect, at least partially disposed in or on the substrate, includes the first filter structure, the second filter structure and the third filter structure, wherein the interconnect is compatible with a camera physical layer standard. In another embodiment, the camera physical layer standard is defined by a MIPI C-PHY specification. In another embodiment, the first filter structure, the second filter structure and the third filter structure each include a respective conductive trace portion that forms a sequence of corrugations in or on the substrate. In another embodiment, three capacitances are each to be provided with different respective one of the first filter structure, the second filter structure and the third filter structure, wherein one of the three capacitances differs by at least five percent from another of the three capacitances. In another embodiment, the one of the three capacitances differs by at least ten percent from the other of the three capacitances. In another embodiment, a three-wire data channel, disposed in or on the substrate, includes the first filter structure, the second filter structure and the third filter structure, wherein the three-wire data channel is located within a region of the substrate, wherein a total cross-sectional area of the region is equal to or less than a 1 square centimeter.

Techniques and architectures for communicating image information are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A device comprising:
a substrate having disposed therein or thereon:
a first filter structure to perform a first filtering of a first signal to generate a first modified signal;
a second filter structure to perform a second filtering of a second signal to generate a second modified signal; and
a third filter structure to perform, concurrently with the first filtering and the second filtering, a third filtering of a third signal to generate a third modified signal, wherein a combination of the first signal, the second signal and the third signal communicate a symbol representing image data; and
first integrated circuitry coupled to concurrently exchange with the substrate one of:
a first signal triad including the first signal, the second signal and the third signal; and
a second signal triad including the first modified signal, the second modified signal and the third modified signal.

2. The device of claim 1, wherein the device includes a printed circuit board comprising the substrate.

3. The device of claim 1, wherein an interconnect, at least partially disposed in or on the substrate, includes the first filter structure, the second filter structure and the third filter structure, wherein the interconnect is compatible with a camera physical layer standard.

4. The device of claim 3, wherein the camera physical layer standard defined by a MIPI C-PHY specification.

5. The device of claim 1, wherein the first filter structure, the second filter structure and the third filter structure each include a respective conductive trace portion that forms a sequence of corrugations in or on the substrate.

6. The device of claim 1, wherein three capacitances are each to be provided with different respective one of the first filter structure, the second filter structure and the third filter structure, wherein one of the three capacitances differs by at least five percent from another of the three capacitances.

7. The device of claim 6, wherein the one of the three capacitances differs by at least ten percent from the other of the three capacitances.

8. The device of claim 1, wherein a three-wire data channel, disposed in or on the substrate, includes the first filter structure, the second filter structure and the third filter structure, wherein the three-wire data channel is located within a region of the substrate, wherein a total cross-sectional area of the region is equal to or less than a 1 square centimeter.

9. A method comprising:
concurrently performing each of:
first filtering of a first signal with a first filter structure, wherein the first filtering generates a first modified signal;
second filtering of a second signal with a second filter structure, wherein the second filtering generates a second modified signal; and
third filtering of a third signal with a third filter structure, wherein the third filtering generates a third modified signal,
wherein the first signal, the second signal and the third signal are provided by first integrated circuitry coupled to a substrate, wherein the first filter structure, the second filter structure and the third filter structure are each disposed in or on the substrate,
wherein a combination of the first signal, the second signal and the third signal communicate a symbol representing image data; and
sending the first modified signal, the second modified signal and the third modified signal from the substrate to second integrated circuitry.

10. The method of claim 9, wherein the device includes a printed circuit board comprising the substrate.

11. The method of claim 9, wherein an interconnect, at least partially disposed in or on the substrate, includes the first filter structure, the second filter structure and the third filter structure, wherein the interconnect is compatible with a camera physical layer standard.

12. The method of claim 11, wherein the camera physical layer standard defined by a MIPI C-PHY specification.

13. The method of claim 9, wherein the first filter structure, the second filter structure and the third filter structure each include a respective conductive trace portion that forms a sequence of corrugations in or on the substrate.

14. The method of claim 9, further comprising providing three capacitances each with a different respective one of the first filter structure, the second filter structure and the third filter structure, wherein one of the three capacitances differs by at least five percent from another of the three capacitances.

15. A system comprising:
a device including:
a substrate having disposed therein or thereon:
a first filter structure to perform a first filtering of a first signal to generate a first modified signal;
a second filter structure to perform a second filtering of a second signal to generate a second modified signal; and
a third filter structure to perform, concurrently with the first filtering and the second filtering, a third filtering of a third signal to generate a third modified signal, wherein a combination of the first signal, the second signal and the third signal communicate a symbol representing image data; and
first integrated circuitry coupled to concurrently exchange with the substrate one of:
a first signal triad including the first signal, the second signal and the third signal; and
a second signal triad including the first modified signal, the second modified signal and the third modified signal; and
a display coupled to the substrate, the display to generate an image based on the image data.

16. The system of claim 15, wherein the device includes a printed circuit board comprising the substrate.

17. The system of claim 15, wherein an interconnect, at least partially disposed in or on the substrate, includes the first filter structure, the second filter structure and the third filter structure, wherein the interconnect is compatible with a camera physical layer standard.

18. The system of claim 17, wherein the camera physical layer standard defined by a MIPI C-PHY specification.

19. The system of claim 15, wherein the first filter structure, the second filter structure and the third filter structure each include a respective conductive trace portion that forms a sequence of corrugations in or on the substrate.

20. The system of claim 15, wherein a three-wire data channel, disposed in or on the substrate, includes the first filter structure, the second filter structure and the third filter structure, wherein the three-wire data channel is located within a region of the substrate, wherein a total cross-sectional area of the region is equal to or less than a 1 square centimeter.
